(19) United States
(12) Patent Application Publication
(10) Pub. No.: US 2026/0175889 A1
(43) Pub. Date: Jun. 25, 2026

(54) Folding Cart

(71) Applicant: Zhejiang Hengfeng Top Leisure Co., Ltd., Zhejiang (CN)

(72) Inventor: Baoqing Yang, HangZhou (CN)

(21) Appl. No.: 18/835,250

(22) PCT Filed: Oct. 11, 2023
(86) PCT No.: PCT/CN2023/123989

§ 371 Date: Apr. 30, 2025

(30) Foreign Application Priority Data
Oct. 12, 2022 (CN) 202222703400.1

(51) Int. Cl. B62B 3/02; B62B 3/00

(52) U.S. Cl. CPC B62B 3/025; B62B 3/007; B62B 2205/06

(57) ABSTRACT

Disclosed in the present application is a folding cart. The folding cart comprises: end face cross tube assemblies, side face cross tube assemblies, a bottom frame cross tube assembly and four vertical tubes, wherein the end face cross tube assembly and the side face cross tube assembly, which are adjacent to each other, are connected by means of one vertical tube. The bottom frame cross tube assembly is connected to the four vertical tubes. The end face cross tube assemblies, the side face cross tube assemblies and the bottom frame cross tube assembly can all be folded, such that any two adjacent vertical tubes can move close to each other or away from each other. Each side face cross tube assembly comprises two first cross tubes, two first mounting tubes and two second cross tubes, wherein first ends of the first cross tubes are hinged to each other, second ends of the first cross tubes are hinged to first ends of the first mounting tubes, and second ends of the first mounting tubes are hinged to the vertical tubes; and first ends of the second cross tubes are hinged to each other, and second ends of the second cross tubes are connected to the top ends of the vertical tubes. The first cross tube and the second cross tube, which are close to the same vertical tube, are arranged in a crossed manner. The structure of the folding cart is supported in a stable manner and the occupied volume of the folding cart is reduced after folding.

### TECHNICAL FIELD

The present application relates to the technical field of folding wagons, and in particular to a folding cart.

### BACKGROUND TECHNIQUE

Traditional foldable cart products still occupy a large area after being folded, which will increase transportation costs and reduce convenience. The problem of the existing technology is that the link mechanism used for folding is single, and it is difficult to further optimize the folding effect.

Therefore, how to provide a folding cart structure with a strong folding effect and a small occupied area after folding is a problem that needs to be solved by those skilled in the art.

### UTILITY MODEL CONTENT

The purpose of the present application is to provide a folding cart with a high degree of folding completion, a small volume after folding, and a sufficient volume after unfolding.

To achieve the above-mentioned purpose, the present application provides a folding cart, comprising: an end cross tube assembly, a side cross tube assembly, a bottom frame cross tube assembly and four vertical tubes; adjacent end cross tube assemblies and side cross tube assemblies are respectively connected through a vertical tube, and the bottom frame cross tube assembly is respectively connected to the four vertical tubes; the end cross tube assembly, the side cross tube assembly and the bottom frame cross tube assembly can all be folded so that any two adjacent vertical tubes are close to and away from each other; the side cross tube assembly comprises: two first cross tubes, two first mounting tubes and two second cross tubes; the first ends of the two first cross tubes are hinged to each other, the second ends of the first cross tubes are hinged to the first ends of the first mounting tubes, and the second ends of the first mounting tubes are correspondingly hinged to the lower parts of the vertical tubes; the first ends of the two second cross tubes are hinged to each other, and the second ends of the second cross tubes are connected to the top ends of the vertical tubes; the first cross tubes and the second cross tubes close to the same vertical tube are cross-arranged, and the intersection of the two is rotationally connected.

In some embodiments, the side cross tube assembly further includes: two second mounting tubes; the first end of the second mounting tube is slidably connected to the vertical tube via a slider, and the second end of the second mounting tube is hinged to the second cross tube accordingly.

In some embodiments, the end face cross tube assembly includes: two third cross tubes and two fourth cross tubes; the first ends of the two third cross tubes are hinged to each other, and the second ends of the two third cross tubes are connected to corresponding sliders; the first ends of the two fourth cross tubes are hinged to each other, and the second ends of the fourth cross tubes are respectively connected to the top ends of the two vertical tubes; the third cross tube and the fourth cross tube connected to the same vertical tube are cross-arranged, and the two are rotationally connected at the intersection.

In some embodiments, the bottom frame cross tube assembly includes: four first base tubes, four second base tubes, two bidirectional hinged seats and two four-way hinged seats; the bidirectional hinged seat is connected to the side of the first end of the second cross tube, any bidirectional hinged seat is hinged with two first base tubes, and any bidirectional hinged seat is respectively connected to two four-way hinged seats through the first base tube; the four second base tubes are correspondingly connected to the bottom ends of the four vertical tubes, and the two second base tubes of the cross tube assembly close to the same end face are connected to the same four-way hinged seat.

In some embodiments, the bottom frame cross tube assembly includes: four third base tubes and a four-way hinge seat; the four third base tubes are correspondingly connected to the bottom ends of the four vertical tubes, and the four third base tubes are all connected to the same four-way hinge seat.

In some embodiments, the end face cross tube assembly includes: two fifth cross tubes and two third mounting tubes; the middle parts of the two fifth cross tubes are rotatably connected, the first ends of the two fifth cross tubes are respectively connected to the top ends of the two vertical tubes, the second ends of the two fifth cross tubes are respectively connected to the first ends of the two third mounting tubes, and the second ends of the two third mounting tubes are respectively connected to the sides of the two vertical tubes.

In some embodiments, a movable roller is correspondingly provided at the lower end of any vertical tube.

In some embodiments, a folding rod is provided between two vertical tubes corresponding to the end face cross tube assembly. The folding rod can be folded following the relative movement of the vertical tubes, and a handle assembly is sleeved on the folding rod.

Compared with the above background technology, the present application is provided with an end cross tube assembly, a side cross tube assembly, a bottom frame cross tube assembly and four vertical tubes; the adjacent end cross tube assemblies and the side cross tube assemblies are connected by a vertical tube respectively. The bottom frame cross tube assembly is connected to four vertical tubes respectively. The end cross tube assembly, the side cross tube assembly and the bottom frame cross tube assembly can all be folded so that any two adjacent vertical tubes can be close to and away from each other. The side cross tube assembly includes: two first cross tubes, two first mounting tubes and two second cross tubes; the first ends of the first cross tubes are hinged to each other, the second ends of the first cross tubes are hinged to the first ends of the first mounting tubes, and the second ends of the first mounting tubes are hinged to the vertical tubes; the first ends of the two second cross tubes are hinged to each other, and the second ends of the second cross tubes are connected to the top ends of the vertical tubes. The first cross tubes and the second cross tubes close to the same vertical tube are cross-arranged. When the folding cart is opened, the structure of the cross tubes can stably support the main body of the folding cart; when the folding cart is folded, the hinge position of the first cross tube and the first mounting tube moves downward, thereby reducing the volume after folding.

### BRIEF DESCRIPTION OF THE DRAWINGS

In order to more clearly illustrate the embodiments of the present application or the technical solutions in the prior art, the drawings required for use in the embodiments or the description of the prior art will be briefly introduced below. Obviously, the drawings described below are merely embodiments of the present application. For ordinary technicians in this field, other drawings can be obtained based on the provided drawings without paying any creative work.

FIG. 1 is a schematic structural diagram of a folding cart in a first embodiment of the present application;

FIG. 2 is a side view of the folding cart in the first embodiment of the present application;

FIG. 3 is a top view of the folding cart in the first embodiment of the present application;

FIG. 4 is a schematic structural diagram of the folding cart in the folded state according to the first embodiment of the present application;

FIG. 5 is a side view of FIG. 4;

FIG. 6 is a side view of the foldable cart in the first embodiment of the present application after being fully folded;

FIG. 7 is a side view of the bottom frame cross tube assembly in the first embodiment of the present application in a folded state;

FIG. 8 is a side view of the bottom frame cross tube assembly in the first embodiment of the present application when it is completely folded;

FIG. 9 is a schematic structural diagram of a folding cart in a second embodiment of the present application;

FIG. 10 is a schematic structural diagram of the folding cart in the folded state according to the second embodiment of the present application;

FIG. 11 is a top view of a folding cart in a second embodiment of the present application;

FIG. 12 is a side view of a folding cart in a second embodiment of the present application;

FIG. 13 is a front view of a folding cart in a third embodiment of the present application;

FIG. 14 is a front view of a folding cart in a fourth embodiment of the present application.

Among them: 1—end face cross tube assembly, 11—third cross tube, 12—fourth cross tube, 13—fifth cross tube, 14—third mounting tube; 2—side cross tube assembly, 21—first cross tube, 22—first mounting tube, 23—second cross tube, 24—second mounting tube; 3—bottom frame cross tube assembly, 31—first base tube, 32—second base tube, 33—two-way hinged seat, 34—four-way hinged seat, 35—third base tube; 4—vertical tube, 5—slider, 6—moving roller, 7—folding rod, 8—handle assembly.

### IMPLEMENTATION

The following will be combined with the drawings in the embodiments of the present application to clearly and completely describe the technical solutions in the embodiments of the present application. Obviously, the described embodiments are only part of the embodiments of the present application, not all of the embodiments. Based on the embodiments in the present application, all other embodiments obtained by ordinary technicians in this field without creative work are within the scope of protection of this application.

In order to enable those skilled in the art to better understand the present application, the present application is further described in detail below in conjunction with the accompanying drawings and specific implementation methods.

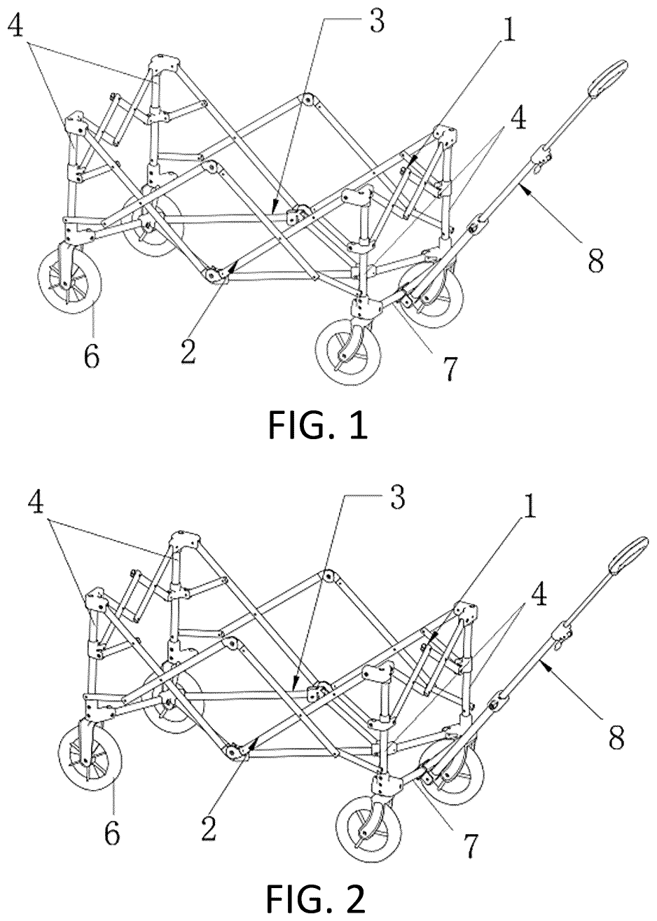

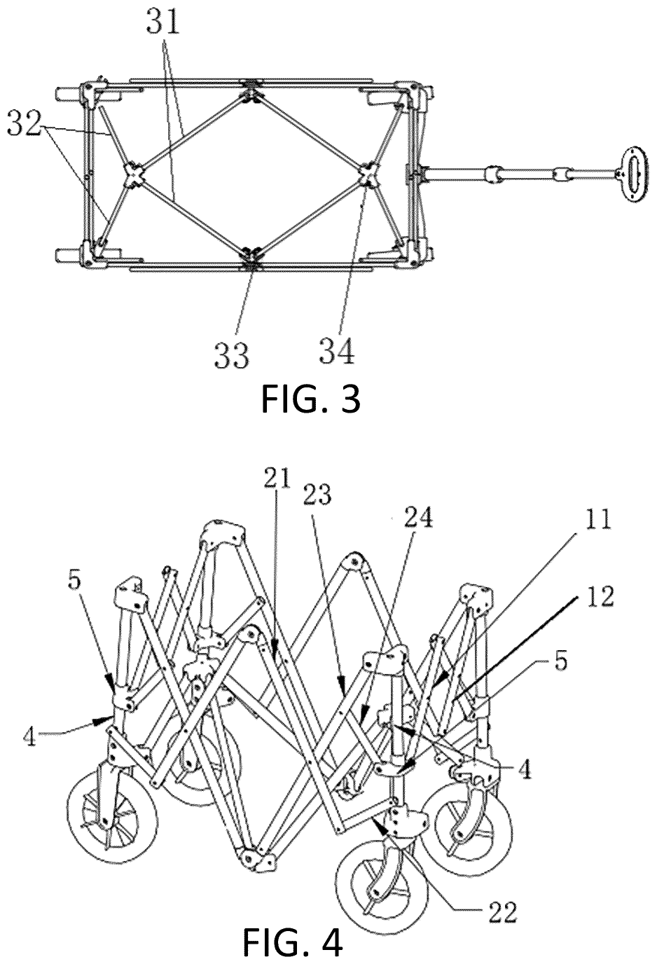

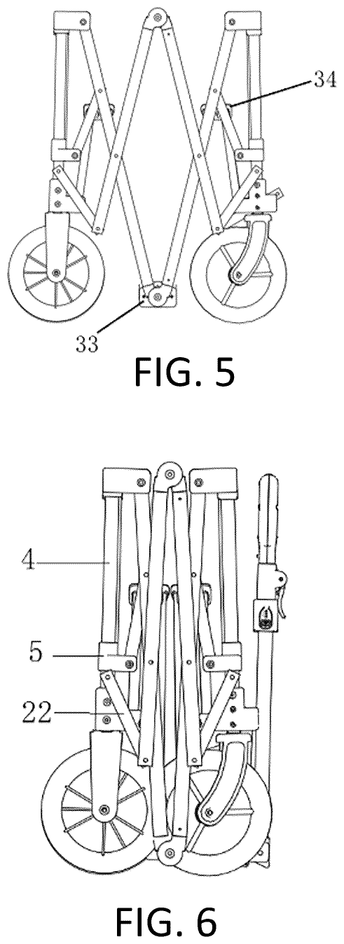

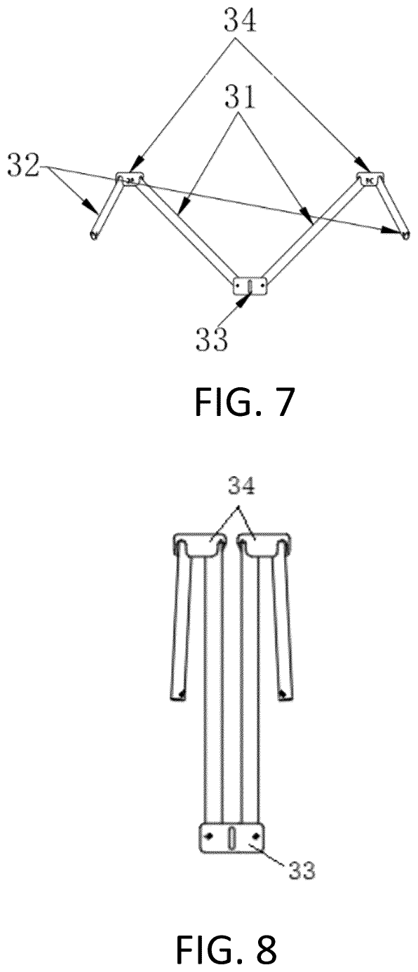

Referring to FIGS. 1 to 8 of the specification, FIG. 1 is a structural schematic diagram of the folding vehicle in the first embodiment of the present application, FIG. 2 is a side view of the folding vehicle in the first embodiment of the present application, FIG. 3 is a top view of the folding vehicle in the first embodiment of the present application, FIG. 4 is a structural schematic diagram of the folding vehicle in the folded state in the first embodiment of the present application, FIG. 5 is a side view of FIG. 4, FIG. 6 is a side view of the folding vehicle in the first embodiment of the present application after it is fully folded, FIG. 7 is a side view of the bottom frame cross tube assembly in the first embodiment of the present application in the folded state, and FIG. 8 is a side view of the bottom frame cross tube assembly in the first embodiment of the present application when it is fully folded, comprising: an end cross tube assembly 1, a side cross tube assembly 2, a bottom frame cross tube assembly 3 and four vertical tubes 4; the four vertical tubes 4 are distributed in a rectangular shape, that is, there are two adjacent vertical tubes 4 on the side of any vertical tube 4, and the sides of the two adjacent vertical tubes 4 are connected by an end cross tube assembly 1 or a side cross tube assembly 2, that is, the adjacent end cross tube groups 1 and the side cross tube assemblies 2 are respectively connected by a vertical tube 4. The side cross tube assembly 2 forms the long side of the rectangular structure, and the end cross tube assembly 1 forms the short side of the rectangular structure, so that the four vertical tubes 4 are connected in sequence to form the side frame of the folding cart. The bottom frame cross tube assembly 3 is connected to the lower parts of the four vertical tubes 4 respectively, so as to form the bottom frame of the folding cart.

The end cross tube assembly 1, the side cross tube assembly 2 and the bottom frame cross tube assembly 3 can all be folded, so that any two adjacent vertical tubes 4 can be moved closer to or farther from each other. When the folding cart is opened, the cross tube structure can stably support the main body of the folding cart; when the folding cart is folded, the cross tube structure can be folded to achieve rapid folding between the vertical tubes 4 and reduce the volume of the main body after folding.

The side cross tube assembly 2 includes: two first cross tubes 21, two first mounting tubes 22 and two second cross tubes 23; the first ends of the two first cross tubes 21 are hinged to each other, and the second end of any first cross tube 21 is hinged to the first end of the corresponding first mounting tube 22, and the second end of the first mounting tube 22 is hinged to the lower part of the corresponding vertical tube 4; the first ends of the two second cross tubes 23 are hinged to each other, and the second end of any second cross tube 23 is fixedly connected to the top of the corresponding vertical tube 4. The first cross tube 21 and the second cross tube 23 close to the same vertical tube 4 are cross-arranged, and the intersection is rotatably connected, forming two intersections in the side cross tube assembly 2, forming two X-shaped cross mechanisms.

When the two vertical tubes 4 connected to the side cross tube assembly 2 are close to each other, the second end of the second cross tube 23 is fixedly connected to the vertical tube 4, and with the two intersection points as axes, the two second cross tubes 23 are close to each other and the hinge points of the first ends are moved downward, the two first cross tubes 21 are close to each other and the hinge points of the first ends are lifted up, and the second ends of the first cross tubes 21 are hinged to the vertical tube 4 through the first mounting tube 22, and the hinge position of the first cross tube 21 and the first mounting tube 22 is moved downward. Since the lower part of the folding cart has sufficient moving space, the folding effect of the side cross tube assembly 2 will be enhanced, thereby reducing the volume after folding.

When the two vertical pipes 4 connected by the side cross pipe assembly 2 move away from each other, the above-mentioned structures move in the opposite direction. The movement principle is the same as above and will not be repeated.

Furthermore, the side cross tube assembly 2 further includes: two second mounting tubes 24; the first ends of the second mounting tubes 24 are slidably connected to the vertical tube 4 via the slider 5, the slider 5 can slide along the length direction of the vertical tube 4, and the second ends of the second mounting tubes 24 are hinged to the corresponding second cross tubes 23. The cooperation between the second mounting tubes 24 and the slider 5 increases the stability of the folded structure.

When the two vertical tubes 4 connected to the side cross tube assembly 2 are close to each other, the second end of the second cross tube 23 is fixedly connected to the vertical tube 4, and the two cross points are used as axes. The two second cross tubes 23 are close to each other and the hinge point of the first end is moved downward, and the second installation tube 24 is hinged with the slider 5 and the second cross tube 23 to obtain a folding space between the second cross tube 23 and the vertical tube 4. At the same time, the two first cross tubes 21 are close to each other and the hinge point of the first end is lifted up, and the second end of the first cross tube 21 is hinged with the vertical tube 4 through the first installation tube 22 to obtain a folding space.

When the two vertical pipes 4 connected by the side cross pipe assembly 2 move away from each other, the above-mentioned structures move in the opposite direction. The movement principle is the same as above and will not be repeated.

Furthermore, the above-mentioned end face cross tube assembly 1 includes: two third cross tubes 11 and two fourth cross tubes 12; the first ends of the two third cross tubes 11 are hinged to each other, and the second ends of the two third cross tubes 11 are respectively connected to the corresponding two sliders 5; the first ends of the two fourth cross tubes 12 are hinged to each other, and the second ends of the fourth cross tubes 12 are respectively connected to the top ends of the two vertical tubes 4; and the third cross tube 11 and the fourth cross tube 12 connected to the same vertical tube 4 are cross-arranged, and the intersection of the two is rotatably connected to form two intersection points in the end face cross tube assembly 1.

When the two vertical tubes 4 connected by the end face cross tube assembly 1 approach each other, the second end of the third cross tube 11 is fixedly connected to the vertical tube 4, and with the two intersection points as axes, the two third cross tubes 11 approach each other and lift up the hinge points of the first ends, and the two fourth cross tubes 12 approach each other and move the hinge points of the first ends downward, and the slider 5 at the second end of the first cross tube 12 moves downward along the surface of the vertical tube 4 to obtain space for folding and moving.

When the two vertical pipes 4 connected by the end face cross pipe assembly 1 move away from each other, the above structures move in the opposite direction. The movement principle is the same as above and will not be repeated.

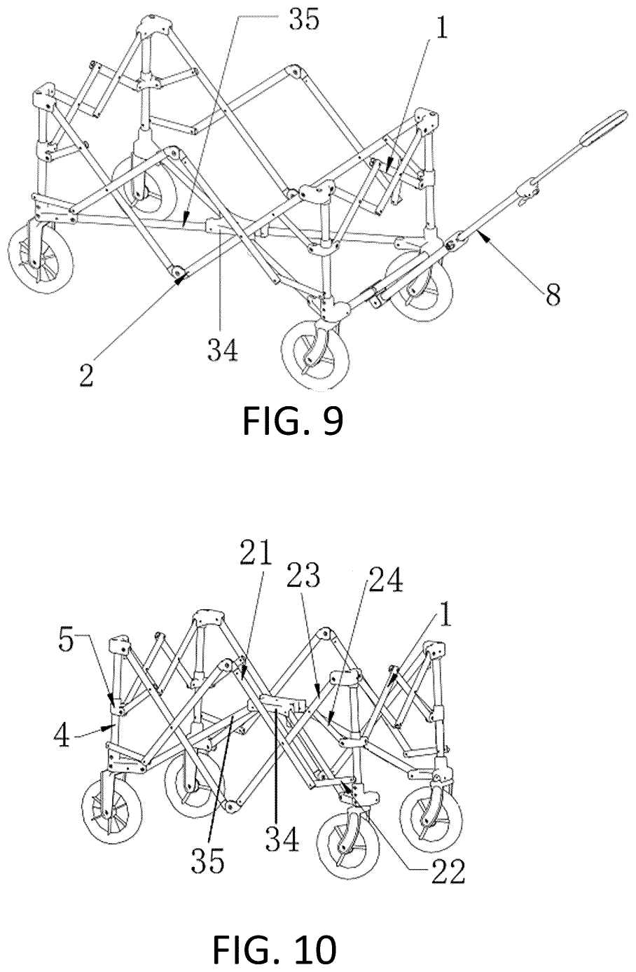

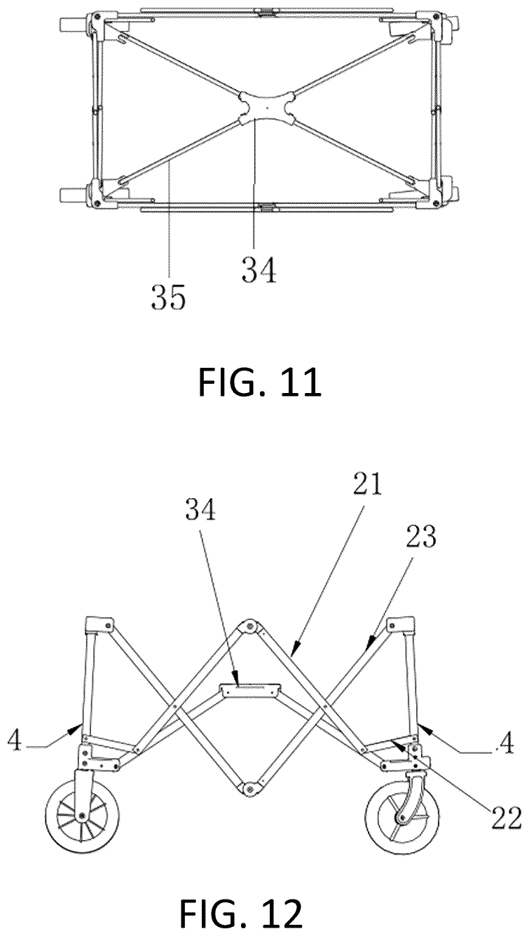

Further, referring to the attached drawings 9 to 12 of the specification, FIG. 9 is a schematic structural diagram of the folding vehicle in the second embodiment of the present application, FIG. 10 is a schematic structural diagram of the folding vehicle in the folded state in the second embodiment of the present application, FIG. 11 is a top view of the folding vehicle in the second embodiment of the present application, and FIG. 12 is a side view of the folding vehicle in the second embodiment of the present application, including the above-mentioned bottom frame cross tube assembly 3 includes: four first base tubes 31, four second base tubes 32, two bidirectional articulated seats 33 and two four-way articulated seats 34; the bidirectional articulated seats 33 are connected to the side of the first end of the second cross tube 23, and rise and fall synchronously with the first end of the second cross tube 23. Any bidirectional articulated seat 33 is articulated with two first base tubes 31, and any bidirectional articulated seat 33 is respectively connected to two four-way articulated seats 34 through the first base tube 31, that is, the two first base tubes 31 connected to the bidirectional articulated seat 33 are respectively connected to two different four-way articulated seats 34. The four first base tubes 31 are connected to form a diamond structure with the two-way hinge seat 33 and the four-way hinge seat 34 as the four end points. The four second base tubes 32 are respectively connected to the bottom ends of the four vertical tubes 4, and the two second base tubes 32 near the same end cross pipe assembly 1 are connected to the same four-way hinge seat 34.

The above-mentioned hinge seat structure can be realized by the bottom frame plastic part and the soft surface webbing, and it can be easily moved by the cross tube structure when the folding cart is folded. In one embodiment of the present application, the two-way hinge seat 33 as a driving position follows the first end of the second cross tube 23 to move downward, and the first base tube 31 is correspondingly folded upward to lift the four-way hinge seat 34 to realize the folding of the bottom frame cross tube assembly 3. When the bottom frame cross tube assembly 3 is unfolded, the above-mentioned structures move in the opposite direction, and the movement principle is the same as above, which will not be repeated.

Furthermore, the above-mentioned bottom frame cross tube assembly 3 includes: four third base tubes 35 and a four-way hinge seat 34; the four third base tubes 35 are correspondingly connected to the bottom ends of the four vertical tubes 4, and the four third base tubes 35 are all connected to the same four-way hinge seat 34. The four-way hinge seat 34 in the middle is directly lifted up by the four third base tubes 35 to realize the folding of the bottom frame.

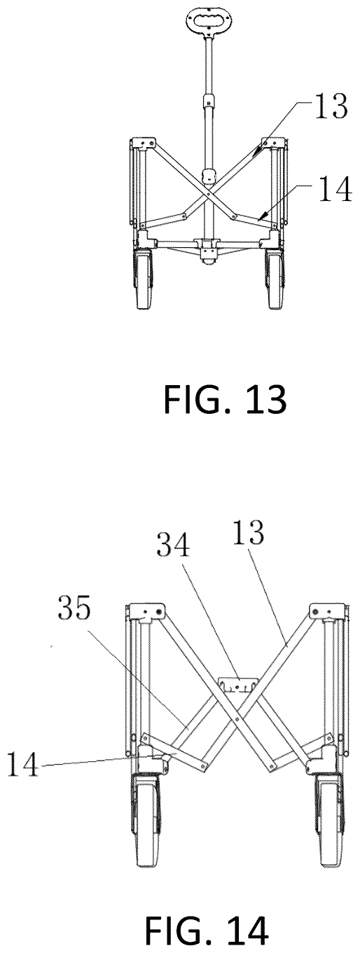

Further, referring to the attached drawings 13 and 14 of the specification, FIG. 13 is a front view of the folding cart in the third embodiment of the present application, and FIG. 14 is a front view of the folding cart in the fourth embodiment of the present application, including: the end cross tube assembly 1 includes: two fifth cross tubes 13 and two third mounting tubes 14; the middle parts of the two fifth cross tubes 13 are rotatably connected to form a cross point. The first ends of the two fifth cross tubes 13 are respectively connected to the top ends of the two vertical tubes 4, the second ends of the two fifth cross tubes 13 are respectively connected to the first ends of the two third mounting tubes 14, and the second ends of the two third mounting tubes 14 are respectively connected to the sides of the two vertical tubes 4.

FIG. 13 shows the structure of the end face cross tube assembly 1 cooperating with the bottom frame cross tube assembly 3 of the first embodiment, and FIG. 14 shows the structure of the end face cross tube assembly 1 cooperating with the bottom frame cross tube assembly 3 of the second embodiment.

Furthermore, a movable roller 6 is correspondingly provided at the lower end of any vertical tube 4, and the movable roller 6 can realize the movement of the folding cart frame and the relative movement between several vertical tubes 4.

Furthermore, a folding rod 7 is provided between the two vertical tubes 4 corresponding to the end face cross tube assembly 1, and a handle assembly 8 is sleeved on the folding rod 7. The handle assembly 8 is used to pull the folding cart, and the folding rod 7 and one of the end face cross tube assemblies 1 are arranged in the same vertical plane, and the middle part of the folding rod 7 can be bent with the relative movement between the vertical tubes 4 to achieve a folding effect. The specific structure of the folding rod 7 can refer to the prior art, and will not be expanded in this article.

It should be noted that, in this specification, relational terms such as first and second are merely used to distinguish one entity from other entities, but do not necessarily require or imply any actual relationship or order between these entities.

1. A folding cart, characterized in that it comprises: an end cross tube assembly (1), a side cross tube assembly (2), a bottom frame cross tube assembly (3) and four vertical tubes (4);
the adjacent end cross tube assemblies (1) and the side cross tube assemblies (2) are respectively connected via one vertical tube (4), and the bottom frame cross tube assemblies (3) are respectively connected to four vertical tubes (4);
the end face cross tube assembly (1), the side cross tube assembly (2) and the bottom frame cross tube assembly (3) can all be folded so that any two adjacent vertical tubes (4) can be moved closer to or farther from each other;
the side cross tube assembly (2) comprises: two first cross tubes (21), two first mounting tubes (22) and two second cross tubes (23);
the first ends of the two first cross tubes (21) are hinged to each other, the second end of the first cross tube (21) is hinged to the first end of the first mounting tube (22), and the second end of the first mounting tube (22) is correspondingly hinged to the lower part of the vertical tube (4);
the first ends of the two second cross tubes (23) are hinged to each other, and the second ends of the second cross tubes (23) are connected to the top end of the vertical tube (4);
the first cross tube (21) and the second cross tube (23) close to the same vertical tube (4) are arranged crosswise, and the intersection of the two is rotatably connected.

2. The folding bicycle according to claim 1, characterized in that the side cross tube assembly (2) further comprises: two second mounting tubes (24);
the first end of the second mounting tube is slidably connected to the vertical tube

(4) via a slider (5), and the second end of the second mounting tube (24) is correspondingly hinged to the second cross tube (23).

3. The folding bicycle according to claim 2 is characterized in that the end cross tube assembly (1) comprises: two third cross tubes (11) and two fourth cross tubes (12);
the first ends of the two third cross tubes (11) are hinged to each other, and the second ends of the two third cross tubes (11) are connected to the corresponding sliders (5);
the first ends of the two fourth cross tubes (12) are hinged to each other, and the second ends of the fourth cross tubes (12) are respectively connected to the top ends of the two vertical tubes (4);
the third cross tube (11) and the fourth cross tube (12) connected to the same vertical tube (4) are arranged crosswise, and the intersection of the two is rotationally connected.

4. The folding bicycle according to claim 3 is characterized in that the bottom frame cross tube assembly (3) comprises: four first base tubes (31), four second base tubes (32), two two-way articulated seats (33) and two four-way articulated seats (34);
the bidirectional hinge seat (33) is connected to the side surface of the first end of the second cross tube (23), any bidirectional hinge seat (33) is hinged to two of the first base tubes (31), and any bidirectional hinge seat (33) is respectively connected to two of the four-way hinge seats (34) through the first base tubes (31);
the four second base tubes (32) are correspondingly connected to the bottom ends of the four vertical tubes and the two second base tubes (32) close to the same end face cross tube assembly (1) are connected to the same four-way hinge seat (34).

5. The folding bicycle according to claim 1 is characterized in that the bottom frame cross tube assembly (3) comprises: four third base tubes (35) and a four-way hinge seat (34);
the four third base tubes (35) are correspondingly connected to the bottom ends of the four vertical tubes and the four third base tubes (35) are all connected to the same four-way hinged seat (34).

6. The folding bicycle according to claim 1 is characterized in that the end cross tube assembly (1) comprises: two fifth cross tubes (13) and two third mounting tubes (14);
the middle parts of the two fifth cross tubes (13) are rotatably connected, the first ends of the two fifth cross tubes (13) are respectively connected to the top ends of the two vertical tubes (4), the second ends of the two fifth cross tubes (13) are respectively connected to the first ends of the two third mounting tubes (14), and the second ends of the two third mounting tubes (14) are respectively connected to the side surfaces of the two vertical tubes (4).

7. The folding bicycle according to any one of claims 1-6 is characterized in that a movable roller (6) is correspondingly provided at the lower end of any vertical tube (4).

8. The folding bicycle according to any one of claims 1 to 6 is characterized in that a folding rod (7) is provided between the two vertical tubes (4) corresponding to the end face cross tube assembly (1), and the folding rod (7) can be folded following the relative movement of the vertical tubes and a handle assembly (8) is provided on the folding rod (7).
